(19) United States
(12) Patent Application Publication
(10) Pub. No.: US 2024/0302683 A1
(43) Pub. Date: Sep. 12, 2024

(54) ELECTRONICALLY CONTROLLED DIELECTRIC HUYGENS RESONATOR SPATIAL LIGHT MODULATOR

(71) Applicants: YILDIZ TEKNIK UNIVERSITESI, Istanbul (TR); YILDIZ TEKNOLOJI TRANSFER OFISI ANONIM SIRKETI, Istanbul (TR)

(72) Inventors: Ufuk Gorkem KIRABALI, Istanbul (TR); Huseyin UVET, Istanbul (TR)

(73) Assignees: YILDIZ TEKNIK UNIVERSITESI, Istanbul (TR); YILDIZ TEKNOLOJI TRANSFER OFISI ANONIM SIRKETI, Istanbul (TR)

(21) Appl. No.: 18/039,283

(22) PCT Filed: Jun. 15, 2021
(86) PCT No.: PCT/TR2021/050599

§ 371 Date: May 30, 2023

(30) Foreign Application Priority Data
Nov. 30, 2020 (TR) 2020/19342

(51) Int. Cl. G02F 1/015; G02F 1/01

(52) U.S. Cl. CPC G02F 1/015; G02F 1/0121; G02F 2202/06; G02F 2202/10; G02F 2202/42; G02F 2203/12; G02F 2203/15

(57) ABSTRACT

An electronically controlled dielectric Huygens resonator spatial light modulator is provided. The modulator includes a substrate, a first layer positioned on said substrate, which is transparent at a wavelength, and a second layer that is transparent at the said wavelength; a first semiconductor layer including a charge carrier and a second semiconductor layer including a charge carrier between the first layer and the second layer; and a semiconductor intermediate layer positioned between the first semiconductor layer and the second semiconductor layer. The first layer and the second layer are each equipped with an electronic control circuit to generate electric fields to modulate the charge carriers in the first semiconductor layer and the second semiconductor layer.

### CROSS REFERENCE TO THE RELATED APPLICATIONS

This application is the national phase entry of International Application No. PCT/TR2021/050599, filed on Jun. 15, 2021, which is based upon and claims priority to Turkish Patent Application No. 2020/19342, filed on Nov. 30, 2020, the entire contents of which are incorporated herein by reference.

### TECHNICAL FIELD

The subject of the present improvement relates to an improvement in the field of nanophotonics, in particular to spatial light modulators.

### BACKGROUND

The spatial light modulator (SLM) is a system that modulates the light by changing such parameters as the intensity, phase, polarization and frequency of the light reflected therefrom or passed therethrough.

The spatial light modulator systems (in short: modulators) used in the current scientific literature and industry, which can be referred to as old generation, perform such functions generally by utilizing the variable light refraction of the anisotropic materials (e.g. liquid crystal and similar materials). Light refraction in a system with a modulator can be changed linearly or non-linearly by means of controllers (e.g. electrical, magnetic, optical, mechanical, thermal, etc.), thus modulation is performed. The main obstacles to the development of the relevant systems can be exemplified as follows:
the thickness of the liquid crystals cannot be reduced below a certain limit in order to provide the desired modulation,
the effect of said thickness on the overall response time of the system, and
in the control using electric fields, the pixel size cannot be reduced due to the disturbing effects caused by the interference of the lateral fields.

The pixel size of the existing systems remains at 3.5 micrometers, and the response time is around 100 Hz. Because of the high pixel size, undesirable distortion effects arise when the light is modulated at visible and Near-Infrared wavelengths (i.e., in the range of about 400 to 2500 nanometers).

The light modulators, for which frequent publications are released in the scientific and academic world for the last 10 years, and which can referred to as new generation, are provided using modulated resonators with geometric dimensions smaller than the wavelength of light, which are called metasurfaces. The systems that can be categorized under two general sub-headings as plasmonic (materials with negative dielectric constant, usually metals) and dielectric systems (materials with positive dielectric constant, insulator/semiconductor) are designed based on the wavelength to be modulated. First of all, the following points may be highlighted:
The plasmonic systems cannot provide practical and commercial solutions due to the excess of electrical losses (surface currents) at high optical frequencies.
The dielectric systems in turn suffer much less loss compared to the plasmonic systems, due to the displacement currents formed therein. On the other hand, the deficiencies in the compability of the integrated circuit production facilities with process and material capabilities reduce the time for commercialization of the system.

The dielectric systems have two sub-categories, passive systems and active systems, which can be summarized as follows:
In passive systems, the light modulator, which is manufactured in accordance with the material and geometric shape selected based on the wavelength to be used, can only fulfill the function for which it is designed; for example, in the case of a lens, said lens can only focus the light on a predetermined (calculated at the design stage) focal point, and a different focal point cannot be selected.
Active systems have been introduced to provide a solution to this problem. In active (metasurface) systems, the resonance frequency of a material selected as a resonator, and accordingly its optical properties can be changed (e.g. by electrical, magnetic, optical, mechanical, thermal, methods, etc.), so that different modes of operation of the system are provided. However, the resonance frequency can be adjusted by interfering with the environment around the resonator (for example, by changing the alignment angle of the liquid crystals), and it is possible to ensure the light modulation. Here, it is differentiated from old generation liquid crystal-based systems in that the light modulation is carried out by metasurface resonators, not by the liquid crystals, so it is possible to exceed the limits described above and reach low pixel sizes with high response rates.

The scattering of a plane wave light beam from a plasmonic or dielectric sphere is analytically and fully demonstrated by Gustav Mie et al. by solving Maxwell's equations in spherical coordinates. By solving the related mathematical equations, it is concluded that there are different optical modes (electrical, magnetic, toroidal, etc.) scattering from the sphere. At optical wavelengths, plasmonic spherical bodies act only as electric dipoles because of the electrical currents that occur on their surface, and other optical modes are not provided. However, dielectric spherical bodies can offer a much richer modulation capacity due to the different displacement current modes that may occur therein; in this way, magnetic and toroidal modes can also affect the optical modulation of the system. A practical application of such effects is the so-called Huygens metasurface. In order to observe the Huygens effect, the electric and magnetic dipole resonances must overlap in the spatial plane at the wavelength at which it is operated. If the relevant condition is satisfied, the light incident on the system is scattered only in the forward direction and the efficiency is close to 100%, but also a phase adjustment can be made between 0 and 360 degrees.

### SUMMARY

Principal object of the invention is to provide solutions to the problems mentioned in the prior art.

Another object of the invention is to provide a non-pixel diffraction modulator with a high refresh rate, and a low pixel aperture value.

The improvement of the present application offers a technological development suitable for application in imaging systems used in the health sector; augmented reality systems, LIDARs and holographic displays in the consumer electronics industry; lenses in the optics industry; and sensors in the bioelectronics sector. Therefore, the end products to be obtained by the application of the invention to the industry may include intracorporeal imaging systems, LIDAR, camera lenses, holographic imaging systems, augmented reality glasses and biosensors, each of which is improved.

### BRIEF DESCRIPTION OF THE DRAWINGS

The present invention is exemplified below with reference to the attached figures for better understanding thereof, which examples are only illustrative of the embodiments of the present invention and are not limiting other embodiments and general functions providing the solution of the technical problem.

FIG. 1 is a schematic detail cross-sectional view showing the layers that may be included in an exemplary embodiment of a modulator according to the present application.

FIG. 2 is a schematic detail cross-sectional view, illustrating the emptied areas formed between the semiconductor intermediate layer and the first semiconductor layer, and between the semiconductor intermediate layer and the second semiconductor layer.

FIG. 3 is a schematic detail cross-sectional view, emphasizing that the width of the emptied area increases (the distances between the layers around the emptied areas increase) as the electric field intensity applied on the structure in FIG. 2 is increased.

FIG. 4 is a schematic view of an exemplary embodiment of a modulator 1 according to the context of the present invention, adapted to form a matrix of pixels.

### REFERENCE NUMERALS

1 apparatus (the subject of the invention modulator)
10 pixel
102 substrate
103 first layer
104 first semiconductive layer
105 semiconductive intermediate layer
106 second semiconductive layer
107 second layer
108 emptied area

### DETAILED DESCRIPTION OF THE EMBODIMENTS

Hereinafter, the present invention is described in detail, based on the drawings, whose brief description given above.

The subject of the present application is an electronically controlled dielectric Huygens resonator spatial light modulator (1), which is hereinafter also referred to as “active spatial light modulator” (1), “modulator” (1), or “apparatus” (1) in brief. The modulator (1) which is the subject of the invention can be considered as a dielectric apparatus designed to be a Huygens wave source.

The modulator (1) includes multiple charge carriers whose densities can be controlled electronically. Thus, each charge carrier may apply a predetermined (or desired) phase response to the light passing therethrough. In this way, a predetermined (or desired) waveform can be obtained in 3-dimensional space.

With the invention, it is possible to modulate a resonant frequency of a dielectric material with suitable geometrical properties in order to scatter incident light of a relevant wavelength in such a way that Huygens waves are formed (forward scattering only, Kerker mode).

In this respect, modulation of the resonant frequency takes place according to the following principle:
modulating the densities of the charge carriers
that are located in the connection junctions of the differently doped multiple semiconductors, with the appropriate electric field, and
with such modulation, there occurs a change in said densities of the charge carriers,
in connection with the change, causing a change in the optical properties of said material.

In the present application, a high speed (in the order of gigahertz), high resolution (pixel (10) size in the order of nanometers) “active spatial light modulator” (modulator (1)) can be designed and produced capable of performing 0-360 degrees phase control and suitable to be obtained with existing semiconductor manufacturing processes.

A person skilled in the relevant art, upon reading the invention in this specification, may design the geometry of each pixel (10) of the modulator (1) in such a way that it satisfies the following condition:
the electric and magnetic dipole resonance scattering amplify each other in the direction of the light's travel and attenuate same in the opposite direction, based on the wavelength of an incident light (which reaches the pixel (10) to pass therethrough).

In this way, each pixel (10) can act as a point wave source (such as, a Huygens wave source). Therefore, said pixels (10) can be considered as Huygens wave sources.

The phase response of each pixel (10) (Huygens wave source) to the light passing therethrough varies depending on the charge carrier density of the different semiconductor materials forming said pixel (10). By adjusting the intensity of the electric field to be applied outside, the charge carrier densities of the semiconductor materials can be controlled along a relevant optical path, thus an optical phase response of the modulator (1) can be regulated.

In the present application, by placing the pixel (10) (Huygens wave source) in multiple numbers in 2-dimensional space (e.g., with the light transmission directions being essentially parallel to each other), the spherical waves formed by each pixel (10) will be able to create, in 3D space, interference patterns with each other. An optical waveform projected in 3-dimensional space can be obtained by adjusting the phase response of each pixel (10) individually by applying the required electric fields.

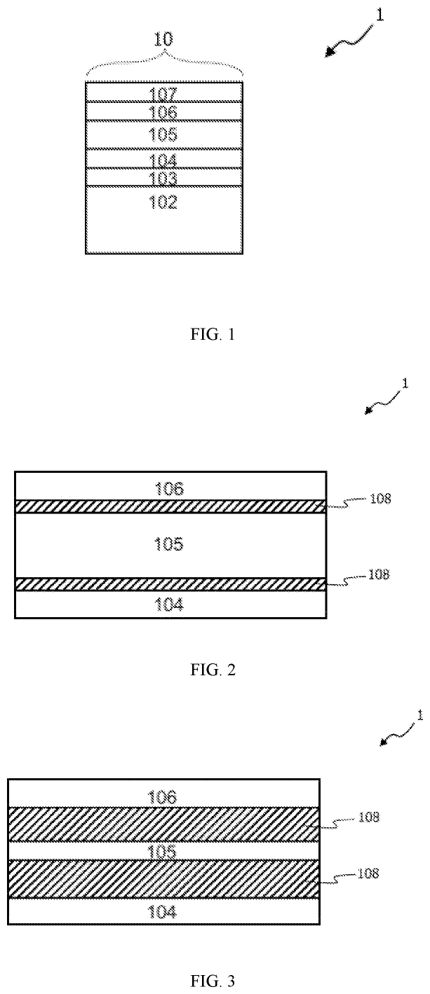

The modulator (1) of the invention includes a substrate (102) and multiple layers formed thereon. For example, the substrate (102) may constitute a (sub) layer supporting the apparatus (modulator (1)), as illustrated in FIG. 1. Exemplary materials suitable for the substrate (102) include rigid (hard) materials such as glass, silicon, quartz, and silicon oxide.

On the substrate (102), there is a first layer (103) and a second layer (107), both of which are transparent at a selected/designed wavelength. Between said first layer (103) and the second layer (107) is located a first semiconductor layer (104) and a second semiconductor layer (106), each including a “charge carrier”.

The first layer (103) and the second layer (107) are provided with electronic control circuits (not shown) to generate electric fields suitable to modulate the charge carriers in the semiconductors interposed between them.

In order to modulate a Huygens wave source (i.e., in the context of the present application: pixel 10)) alone, an electric field can be applied directly to the semiconductor layers (i.e., on the first semiconductor layer (104) and the second semiconductor layer (106) located in said pixel (10)) without requiring any additional electronic circuit equipment such as a transistor.

In the modulator (1) which is the subject of the invention, there is a semiconductor intermediate layer (105) between the first semiconductor layer (104) and the second semiconductor layer (106) within each pixel (10).

If the doping types are to be classified into two alternative types, negative (short: “n”) and positive (short: “p”):
The first semiconductor layer (104) and the second semiconductor layer (106) have a common doping type selected from n and p.
The semiconductor intermediate layer (105), on the other hand, has a doping type selected from n and p, but not included in the first semiconductor layer (104) and the second semiconductor layer (106).

In other words, the first semiconductor layer (104), the second semiconductor layer (106) and the semiconductor intermediate layer (105) are formed from one or more semiconductor materials that are:
selected from Group II, Group III, Group IV, Group V and Group VI in the periodic system of elements, and
doped in such a way that the doping type selected from the negative (n) or positive (p) doping types of the semiconductor intermediate layer (105) is opposite to a doping type in the first semiconductor layer (104) and the second semiconductor layer (106).

Therefore, one of the following two alternatives applies:
the first semiconductor layer (104) and the second semiconductor layer (106) have a negative (n) doping type, while the semiconductor intermediate layer (105) has a positive (p) doping type; or
the first semiconductor layer (104) and the second semiconductor layer (106) have a positive (p) doping type, while the semiconductor intermediate layer (105) has a negative (n) doping type.

Thus, the first semiconductor layer (104), the semiconductor intermediate layer (105) and the second semiconductor layer (106), respectively, provide a p-n-p or a n-p-n configuration.

In this way, both between the first semiconductor layer (104) and the semiconductor intermediate layer (105), and between the second semiconductor layer (106) and the semiconductor intermediate layer (105), the charge carrier-free “emptied areas” (108) are provided, depending on the amount of doping and the semiconductor material/materials used.

The first semiconductor layer (104), the second semiconductor layer (106) and the semiconductor intermediate layer (105) may be produced using materials selected from known semiconductors; said semiconductor materials may be selected, for example, from Group II, Group III, Group IV, Group V and Group VI elements in the periodic system of elements. More preferably, said semiconductor materials may be produced using one or more semiconductor materials selected from Group III, Group IV, and Group V to further suit semiconductor manufacturing processes. These (doped) semiconductor materials can be described through the following examples:
“n-type”, containing/being Group IV (e.g. Si (silicium/silicon)) doped with an element selected from Group V (e.g. P (phosphorus));
“p-type”, containing/being an element selected from Group IV (e.g. Si (silicium/silicon)) doped with an element selected from Group III (e.g. B (boron)); and/or
doped, containing a combination of Group III and Group V elements (e.g. Ga—As (Gallium Arsenide)).

FIG. 2 is a schematic detail cross-sectional view, illustrating the emptied areas (108) formed between the semiconductor intermediate layer (105) and the first semiconductor layer (104), and between the semiconductor intermediate layer (105) and the second semiconductor layer (106).

The width of the emptied area (108) is increased when the intensity of the electric fields is increased, which is to be applied from the first layer (103) and the second layer (107) and will impart reverse polarities to the first semiconductor layer (104) and the second semiconductor layer (106) if the polarity of the semiconductor layer (105) is taken as a reference (i.e., the first semiconductor layer (104) and the second semiconductor layer (106) would be negative, if the semiconductor intermediate layer (105) is n, and would be positive, if the latter is p). Thus, the distances between the semiconductor intermediate layer (105) and the first semiconductor layer (104) and between the semiconductor intermediate layer (105) and the second semiconductor layer (106) (i.e., the width of the emptied area (108)) increase. FIG. 3 is a schematic detail cross-sectional view when the electric field intensity applied on the structure in FIG. 2 is increased. In this context, the increase in the width of the emptied areas (108) is schematically illustrated by the shaded areas in FIG. 3 and highlighted as shown in larger size than FIG. 2.

The present invention additionally provides a modulator (1) in the form of a matrix with more than one pixel (10), including the following:
a plurality of first layers (103) located between the substrate (102) and the second layer (107);
a first semiconductor layer (104) including a charge carrier and a second semiconductor layer (106) including a charge carrier, located between the second layer (107) and each first layer (103);
a semiconductor intermediate layer (105) positioned between each said first semiconductor layer (104) and each second semiconductor layer (106) located between the second layer (107) and each first layer (103);
the second layer (107) and each first layer (103) are each equipped with an electronic control circuit to generate electric fields to modulate the charge carriers in each first semiconductor layer (104) and each second semiconductor layer (106).

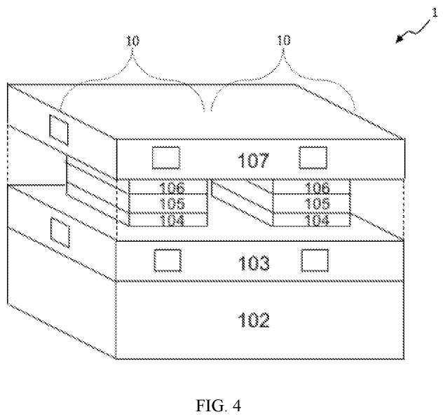

FIG. 4 is a schematic detail view of an exemplary embodiment of the apparatus (i.e., modulator (1)) in the context of the present invention, adapted to form such a matrix of pixels (10). As shown herein, when multiple Huygens wave sources (pixels (10)) are formed to form a matrix on a common substrate (102), a thin film transistor (TFT) layer, for example, can be used in order to select and independently modulate each Huygens wave source. Here, there is a control circuit consisting of a transistor and a capacitor for a pixel (10) (Huygens wave source) corresponding to an intersection of each row and column forming the matrix. Each transparent layer and control circuit for this purpose can be produced, for example, with Indium-Tin-Oxide (ITO) or Zinc-Oxide (ZnO) and by applying suitable doping processes/methods known therefor.

Since the phase response of the system depends on the number of charge carriers therein, the optical distance can be adjusted by applying an electric field suitable for the desired phase response (e.g. an appropriate electric field intensity to obtain the desired phase response). A skilled person reading the present description can easily determine the electric field that must be applied to obtain the desired phase response, by combining this information with general knowledge in the relevant art.

The advantages of the invention compared to the technologies used in the state of the art can be exemplified as follows:
Liquid crystal-based modulators (1) on the market have a pixel (10) aperture value of approximately 3.5 micrometers, even at the best resolution (4K). When working in visible light wavelength, diffraction occurs due to geometric mismatch, and an extra diffraction (pixel (10) diffraction) occurs due to the large distance between the pixels (10), which deteriorates the image quality. With the modulator (1) which is the subject of the invention, since the Huygens wave sources are designed with a geometry suitable for the light used, these problems are eliminated and pixel (10) diffraction does not occur; in addition, small pixel (10) apertures with values below 1 micrometer can be provided, resulting in a clearer image quality compared to liquid crystal-based modulators (1).
Liquid crystal-based modulators (1) on the market have a refresh rate of 100 Hz. Since the physical response, of the liquid crystals used, to the electric field takes a certain period of time, and the crystal size must be selected according to the desired phase setting, higher speeds have not been achieved yet.
Another type of light modulator (1), digital micromirror devices, have a refresh rate in the order of Khz (e.g. 30 KHz), but the pixel (10) apertures are in the order of 10 micrometers and are suitable for logic modulation. Pixel (10) diffraction takes place in digital micromirror devices. In the solution subject to the invention, depending on the speed of the charge carriers in the semiconductor, it is possible to achieve the order of Ghz, and refresh rates in the range of 10 to 50 GHz can be easily achieved; in addition, as mentioned above, pixel (10) diffraction does not occur.

The Huygens metasurfaces in the literature cannot be actively controlled and no functional changes can be made after fabrication. In the solution subject to the invention, the resonance frequency of the device can be actively controlled by electric fields, thereby changing the phase response.

What is claimed is:

1. An electronically controlled dielectric Huygens resonator spatial light modulator, comprising:
a substrate,
a first layer positioned on the substrate, wherein the first layer is transparent at a wavelength, and a second layer transparent at the wavelength;
a first semiconductor layer comprising a charge carrier and a second semiconductor layer each comprising a charge carrier, wherein the first semiconductor layer and the second semiconductor layer are between the first layer and the second layer;
a semiconductor intermediate layer positioned between the first semiconductor layer and the second semiconductor layer;
wherein the first layer and the second layer are each equipped with an electronic control circuit to generate electric fields to modulate the charge carriers in the first semiconductor layer and the second semiconductor layer.

2. The electronically controlled dielectric Huygens resonator spatial light modulator according to claim 1, wherein the first semiconductor layer and the second semiconductor layer have a negative doping type, while the semiconductor intermediate layer has a positive doping type.

3. The electronically controlled dielectric Huygens resonator spatial light modulator according to claim 1, wherein the first semiconductor layer and the second semiconductor layer have a positive doping type, while the semiconductor intermediate layer has a negative doping type.

4. The electronically controlled dielectric Huygens resonator spatial light modulator according to claim 1, wherein the first semiconductor layer the second semiconductor layer and the semiconductor intermediate layer are formed from at least one semiconductor material, wherein the at least one semiconductor material is that are:
selected from Group II, Group III, Group IV, Group V and Group VI in the periodic system of elements, and
doped in such a way that a doping type selected from the negative or positive doping types of the semiconductor intermediate layer is opposite to a doping type in the first semiconductor layer and the second semiconductor layer.

5. The electronically controlled dielectric Huygens resonator spatial light modulator according to claim 4, wherein at least one semiconductor material is selected from Group III, Group IV and Group V.

6. The electronically controlled dielectric Huygens resonator spatial light modulator according to claim 1, formed in a form of a matrix with more than one pixel, comprising the following:
a plurality of first layers located between the substrate and the second layer;
a first semiconductor layer comprising a charge carrier and a second semiconductor layer each comprising a charge carrier, wherein the first semiconductor layer and the second semiconductor layer are located between the second layer and each of the plurality of first layers;
a semiconductor intermediate layer positioned between each first semiconductor layer and each second semiconductor layer, wherein each first semiconductor layer and each second semiconductor layer are located between the second layer and each of the plurality of first layers;
the second layer and each of the plurality of first layers are each equipped with an electronic control circuit to generate electric fields to modulate the charge carriers in each first semiconductor layer and each second semiconductor layer.

7. The electronically controlled dielectric Huygens resonator spatial light modulator according to claim 6, comprising a thin film transistor layer for an independent modulation of the more than one pixel.

8. The electronically controlled dielectric Huygens resonator spatial light modulator according to claim 2, wherein the first semiconductor layer, the second semiconductor layer and the semiconductor intermediate layer are formed from at least one semiconductor material, wherein the at least one semiconductor material is:
selected from Group II, Group III, Group IV, Group V and Group VI in the periodic system of elements, and
doped in such a way that a doping type selected from the negative or positive doping types of the semiconductor intermediate layer is opposite to a doping type in the first semiconductor layer and the second semiconductor layer.

9. The electronically controlled dielectric Huygens resonator spatial light modulator according to claim 3, wherein the first semiconductor layer, the second semiconductor layer and the semiconductor intermediate layer are formed from at least one semiconductor material, wherein the at least one semiconductor material is:
selected from Group II, Group III, Group IV, Group V and Group VI in the periodic system of elements, and
doped in such a way that a doping type selected from the negative or positive doping types of the semiconductor intermediate layer is opposite to a doping type in the first semiconductor layer and the second semiconductor layer.
